(19) United States
(12) Patent Application Publication
(10) Pub. No.: US 2024/0411656 A1
(43) Pub. Date: Dec. 12, 2024

(54) Ansible IntelScan

(71) Applicant: Henry Ou, Clarksburg, MD (US)

(72) Inventor: Henry Ou, Clarksburg, MD (US)

(21) Appl. No.: 18/329,599

(22) Filed: Jun. 6, 2023

(51) Int. Cl. G06F 11/30

(52) U.S. Cl. CPC G06F 11/3093; G06F 11/3006; G06F 11/301

(57) ABSTRACT

Ansible IntelScan is a groundbreaking software tool, characterized by innovative ideas and streamlined code processes. It leverages Ansible to aid system administrators and system engineers in executing their daily tasks more efficiently and effectively. The software eliminates the need for Ansible Modules or Roles, leading to significant time savings and cost reductions for companies. With its modular, user-friendly design, Ansible IntelScan is primed for routine tasks and report creation, serving as an asset for management decision-making. Its ease of use enables even junior administrators with minimal shell scripting knowledge to operate the software, thereby enhancing overall work productivity and cost-efficiency. Ansible IntelScan is compatible with large-scale Linux server environments, supporting simultaneous operations on over 1000 physical and virtual servers. This innovative tool has been rigorously tested and validated on popular Linux distributions such as Red Hat, CentOS, Ubuntu, and Debian in DEV, QA, and Production environments.

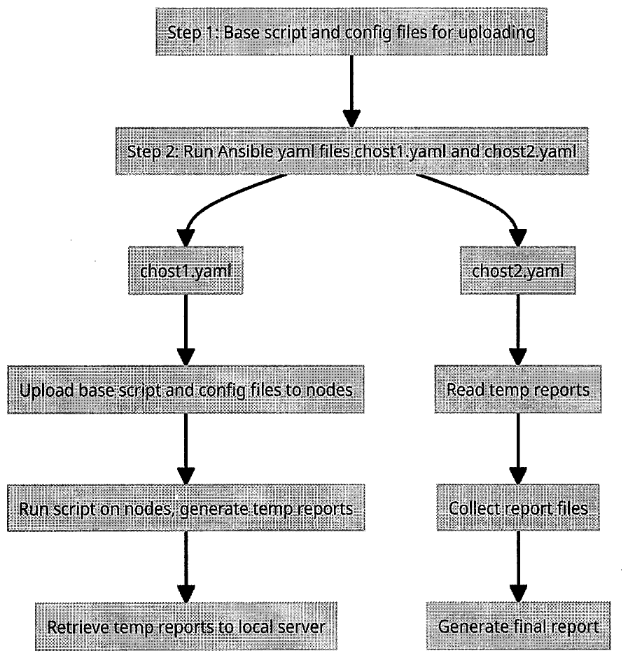

Ansible IntelScan streamlines numerous critical operations including Linux system inventory reporting, cloud configuration, identification of unused cloud volumes, creation of multiple users, and customized security vulnerability scanning. The tool's efficacy has been proven in a variety of applications, such as system inventory management, labor-hour reduction in security company operations, cost savings through the identification of unused cloud resources, timesaving in user creation for US DOD and government projects, and the creation of customized vulnerability scan tools for enhanced security compliance.

With the incorporation of advanced features like playbook execution and report generation, Ansible IntelScan emerges as a dynamic and resourceful toolset for system administrators at all levels of experience.

### 1. INTRODUCTION

a. This is an innovative software program leveraging Ansible, designed to assist system administrators with routine daily tasks. It caters to all system administrators, from junior to senior level.

### 2. BENEFITS

a. No Ansible Module or Ansible Role is needed to run this program, saving approximately 90% of the coding and development time usually spent by Ansible software engineers.
b. The program is modular and structured, ideally suited for the daily repetitive tasks of system administrators and the creation of diverse reports for management decision-making.
c. The program is user-friendly. Users only need to know how to assign keywords to variables in the main template script and then run the playbook.
d. Even junior system administrators with a year or more experience who have a basic understanding of shell scripting can easily use this platform and develop their own customized code. This significantly improves work efficiency and effectiveness, leading to substantial cost savings for companies that use the platform.
e. This platform is suitable for large-scale Linux server environments and can run on 1000+ servers simultaneously. It has been tested and validated on Red Hat, CentOS, Ubuntu, Debian, and more.

### 3. SYSTEM REQUIREMENTS

1) Linux distributions: Red Hat, CentOS, Debian, Ubuntu.
2) Python version 2 or above.
3) Ansible package installed on the server acting as the host.
4) SSH port 22 (or another port if changed) must be open.
5) The current user should have sudo privileges. An SSH key should be created for automatic login into remote hosts.

### 4. PROGRAM DESCRIPTIONS

1) Create a script directory and give it a name of your choice.
2) Within the folder, create a subdirectory named ‘reports’ (lower case).
3) First, modify the template script as requested.
4) Create three YML files named chosts.yml, chosts1.yml, and chosts2.yml:
   i. Chosts.yml is the main file comprising chosts1.yml and chosts2.yml files.
   ii. Chosts1.yml is for connecting to remote hosts and running shell scripts on them. It includes:
      1. Uploading scripts and configuration files from the local or current directory to remote hosts.
      2. Copying related text and/or configuration files to remote hosts, if applicable.
      3. Changing permissions of the scripts appropriately
      4. Running the scripts uploaded to the remote hosts.
      5. Generating a report on remote hosts.
      6. Fetching the report from the remote hosts to the ‘reports’ directory on the main/local server.
      7. Removing the scripts, text, and configuration files after execution on the remote hosts.
   iii. Chosts2.yml is for generating reports. An existing template script named creport.sh can be used to create reports in CSV or Excel format automatically.
5) Create a host file in the current directory (you can use the inventory in /etc/ansible if you prefer).
6) Run the playbook:
   $ ansible-playbook-i host chosts.yml
   Or $ ansible-playbook-i host chosts.yml-f NumberOfForks (This option will run multiple forks simultaneously to save time.)
7) Use the ‘sed’ command to replace keywords according to your needs, such as adjusting the column names or the report's title in the output.
8) Use an SFTP tool to transfer the report to your local computer or use a mail script to send the report to your email account if you have an email service set up on the server.
9) If desired, you can convert the CSV file to Excel format using Excel's ‘Save As’ feature for better formatting.
10) Screenshot:

### 5. HERE ARE SOME ACHIEVEMENTS WITH ANSIBLE INTELSCAN

1) Linux System Inventory Report for a Data Center: This report identified all Linux system inventory with the following information: system hostnames, IP addresses, module information, manufacture dates, CPU numbers, and RAM information. This has assisted management in deciding when to decommission older systems based on their age, improving decision-making efficiency.
2) System Application Configuration and Validation Tools in the Cloud: This addressed a persistent issue that had not been resolved for over two years for a Virginia-based security company, saving approximately 80% of labor hours
3) Cloud Instance Disk Scan Tool: This tool helps to identify unused EC2 volumes, resulting in substantial cost savings for companies.
4) Multiple User Creation Tool: This has saved thousands of labor hours for DOD projects at SAP.
5) Vulnerability Scan Tools: With this platform, you can easily create any customized vulnerability scan tool as needed. For example, quickly determining if a telnet package is installed on remote hosts, or checking if former staff accounts still exist on systems, a violation of security compliance, and so forth.

Inventory Report (Demo Only)

| Num | Host Name | IP Address | Manufacture | Product Name(MB) | Serial Number | CPU Model |
|---|---|---|---|---|---|---|
| 1 | server1 | 192.168.100.1 | Intel | X10DRH-ILN4 | GW189S023742 | Intel(R) Xeon(R) CPU E5-2620 v4 @ 2.10 GHz |
| 2 | server2 | 192.168.100.2 | Intel | X10DRH-ILN4 | GW1875045649 | Intel(R) Xeon(R) CPU E5-2620 v4 @ 2.10 GHz |
| 3 | server3 | 192.168.100.3 | Intel | X11DPi-N | TDK17BS035304 | Intel(R) Xeon(R) Silver 4114 CPU @ 2.20 GHz |
| 4 | server4 | 192.168.100.4 | Intel | A1SRi-2758F | ZK184S015568 | Intel(R) Atom(TM) CPU C2758 @ 2.40 GHz |
| 5 | server5 | 192.168.100.5 | Intel | X10DRH-ILN4 | GWF191S015315 | Intel(R) Xeon(R) CPU E5-2620 v4 @ 2.10 GHz |
| 6 | server6 | 192.168.100.6 | Intel | X8DTL | GW1BS40769 | Intel(R) Xeon(R) CPU E5645 @ 2.40 GHz |
| 7 | server7 | 192.168.100.7 | Intel | X11DPH-T | UK219S011612 | Intel(R) Xeon(R) Silver 4214R CPU @ 2.40 GHz |
| 8 | server8 | 192.168.100.8 | Intel | A1SRi-2758F | ZK184S016183 | Intel(R) Atom(TM) CPU C2758 @ 2.40 GHz |
| 9 | server9 | 192.168.100.9 | Intel | X8DTL | GW25S45009 | Intel(R) Xeon(R) CPU E5645 @ 2.40 GHz |
| 10 | server10 | 192.168.100.10 | Intel | X11DPL-i | UK178S000043 | Intel(R) Xeon(R) Silver 4114 CPU @ 2.20 GHz |
| 11 | server11 | 192.168.100.11 | Intel | X10DRL-i | PP166S015402 | Intel(R) Xeon(R) CPU E5-2630 v4 @ 2.20 GHz |
| 12 | server12 | 192.168.100.12 | Intel | X10DRL-i | PP16BS058768 | Intel(R) Xeon(R) CPU E5-2630 v4 @ 2.20 GHz |
| 13 | server13 | 192.168.100.13 | Intel | X10DRL-i | PP167S042728 | Intel(R) Xeon(R) CPU E5-2630 v4 @ 2.20 GHz |
| 14 | server14 | 192.168.100.14 | Intel | X10DRL-i | PP173S011085 | Intel(R) Xeon(R) CPU ES-2630 v4 @ 2.20 GHz |
| 15 | server15 | 192.168.100.15 | Intel | X9DRD-iF | ZK146S003141 | Intel(R) Xeon(R) CPU E5-2630 v2 @ 2.60 GHz |
| 16 | server16 | 192.168.100.16 | Intel | X10DRL-i | PP16BS059270 | Intel(R) Xeon(R) CPU E5-2630 v4 @ 2.20 GHz |
| 17 | server17 | 192.168.100.17 | Intel | X10DRL-i | PP16BS051169 | Intel(R) Xeon(R) CPU E5-2630 v4 @ 2.20 GHz |
| 18 | server18 | 192.168.100.18 | Intel | X10DRL-i | PP16BS051192 | Intel(R) Xeon(R) CPU E5-2630 v4 @ 2.20 GHz |
| 19 | server19 | 192.168.100.19 | Intel | X11DDW-NT | OM218S007914 | Intel(R) Xeon(R) Silver 4216 CPU @ 2.10 GHz |
| 20 | server20 | 192.168.100.20 | Intel | X10DRL-i | PP161S028343 | Intel(R) Xeon(R) CPU E5-2630 v4 @ 2.20 GHz |
| 21 | server21 | 192.168.100.21 | Intel | X10DRL-i | PP161S027629 | Intel(R) Xeon(R) CPU E5-2630 v4 @ 2.20 GHz |
| 22 | server22 | 192.168.100.22 | Intel | X10DRL-i | PP1735005995 | Intel(R) Xeon(R) CPU E5-2630 v4 @ 2.20 GHz |
| 23 | server23 | 192.168.100.23 | Intel | X11DDW-NT | OM218S007464 | Intel(R) Xeon(R) Silver 4216 CPU @ 2.10 GHz |
| [symbol] | [symbol] | [symbol] | [symbol] | [symbol] | [symbol] | [symbol] |

| Num | Num of CPU | Physical Memory(GB) | Manufacturing Date | Note |
|---|---|---|---|---|
| 1 | 64 | 264 | September 2018 | Redhat |
| 2 | 64 | 264 | July 2018 | Redhat |
| 3 | 40 | 263 | November 2017 | Redhat |
| 4 | 8 | 16 | April 2018 | Redhat |
| 5 | 64 | 65 | September 2011 | Redhat |
| 6 | 24 | 24 | November 2011 | Redhat |
| 7 | 48 | 65 | September 2021 | Redhat |
| 8 | 8 | 8 | April 2018 | Redhat |
| 9 | 24 | 49 | May 2012 | Redhat |
| 10 | 40 | 65 | August 2017 | Redhat |
| 11 | 40 | 65 | June 2016 | Redhat |
| 12 | 40 | 65 | November 2016 | Redhat |
| 13 | 40 | 65 | July 2016 | Redhat |
| 14 | 40 | 65 | March 2017 | Redhat |
| 15 | 24 | 65 | June 2014 | Redhat |
| 16 | 40 | 65 | November 2016 | Redhat |
| 17 | 40 | 65 | November 2016 | Redhat |
| 18 | 40 | 65 | November 2016 | Redhat |
| 19 | 64 | 65 | August 2021 | Redhat |
| 20 | 40 | 65 | January 2016 | Redhat |
| 21 | 40 | 65 | January 2016 | Redhat |
| 22 | 40 | 65 | March 2017 | Redhat |
| 23 | 64 | 65 | August 2021 | Redhat |
| [symbol] | [symbol] | [symbol] | [symbol] | [symbol] |

[symbol]

indicates data missing or illegible when filed

1: A method for managing Linux server environments with an Ansible-based software tool, the method comprising:
1. Eliminating the need for Ansible Modules and Roles, thereby reducing coding, development, and validation time.
2. Enabling users to develop their own customized code to significantly improve work efficiency and effectiveness.
3. Providing a modular and user-friendly software design suited for routine tasks and report creation for management decision-making.
4. Accommodating large-scale Linux server environments and supporting simultaneous operations on over 1000 servers.
5. Creating and modifying script directories and YML files for remote host connection and task execution.
6. Automating the process of uploading scripts to remote hosts, running the scripts, generating, and fetching reports, and removing the scripts after execution.
7. Enabling the generation of diverse reports in CSV or Excel format as needed.
8. Facilitating the execution of Ansible playbook, optionally running multiple forks simultaneously.
9. Allowing for keyword assignment to variables in the main template script by users for customization.
10. Providing capabilities to transfer reports via an SFTP tool or a mail script and convert them to Excel format.
11. Delivering unique software solutions for Linux system inventory management, cloud configuration, identification of unused cloud volumes, creation of multiple users, and customized security vulnerability scanning.

2: The method of claim 1, where the software tool can be used effectively by both junior and senior system administrators, with the only prerequisite being basic understanding of shell scripting.

3: The method of claim 1, where the software tool is compatible with Linux distributions including but not limited to Red Hat, CentOS, Debian, and Ubuntu.

4: The method of claim 1, where the software tool has been tested and validated in DEV, QA, and Production environments.
